(19) United States
(12) Patent Application Publication
(10) Pub. No.: US 2007/0081955 A1
(43) Pub. Date: Apr. 12, 2007

(54) Method and Display for Merchandising Nail Products

(76) Inventor: Heather Suzanne Sopczynski, New York, NY (US)

Correspondence Address: Julie Blackburn;Revlon Consumer Products Corporation, Law Department, 237 Park Avenue, New York, NY, 10017, US

(21) Appl. No.: 11/608,397

(22) Filed: Dec. 8, 2006

(51) Int. Cl. G06Q 50/00

(52) U.S. Cl. 424/61; 705/2

(57) ABSTRACT

A blister pack comprised of a card having a product to be used in a stepwise process for grooming the nails blistered thereto wherein the card contains indicia noting the step of the stepwise nail grooming process the blistered product is to be used in; a retail display where nail care products to be used in a stepwise process for grooming the nails are found in separate corresponding sections of the display; and a method for selling nail care products to be used in a stepwise process for grooming the nails in a retail store environment.

### TECHNICAL FIELD

This invention is in the field of methods and displays for merchandising nail products to be used on steps.

### BACKGROUND OF THE INVENTION

Many cosmetics companies sell in self-select channels such as large mass volume retailers, drug, and food stores. The term “self-select” means that the products are sold in a retail environment where the consumer selects the cosmetic product she wants to buy, generally without the advice and assistance of a beauty advisor. In contrast, in channels of trade such as department stores, cosmetics sales are assisted. The term “assisted” means that cosmetics are sold to the consumer by a beauty advisor who is present to advise the purchaser and select the cosmetics that are best suited to her.

In order to keep their current customers happy and woo more department store purchasers to the mass market, cosmetics companies that sell in the mass market have been working hard to reconfigure their displays to maximize shopability. The displays, or “walls” as they are called in the industry, should be set up such that products are easy to locate and the shopper can readily distinguish between products that are suitable for her and those that are not. The term “shopability” means the ease with which the shopper can shop the wall and find and select the products she is interested in and that are appropriate for her needs.

One example of a cosmetics wall that has improved shopability is set forth in U.S. patent application Ser. No. 11/283,239, filed Nov. 18, 2005, entitled Method and Display for Selling Cosmetic Products. This patent application is directed to a cosmetics display wall, which, among other things, contains eye products that are color coordinated and placed into sections of the wall based upon what eye color they are recommended for. The consumer with, say, blue eyes will shop at the section of a wall marked wall that contains an eye shadow, mascara, and liner products that are pre-selected by the cosmetics company as most suitable for individuals with blue eyes. The products are also color coordinated with each other. Thus, the shopper need only determine her eye color and purchase the products recommended for that color. In another embodiment, the display wall contains face products such as cleanser, toner, moisturizer and foundation that are designed to be applied in steps. The wall contains clearly delineated numbered sections where the products meant to be used in the first step of the beauty process are found in the corresponding first section of the wall, with the products to be used in the second step of the process in the second section of the wall and so on.

Another example of a wall that is designed to improve shopability is set forth in U.S. patent application Ser. No. 11/283,233, filed Nov. 18, 2005, entitled Method and Display for Merchandising Cosmetic Products. This patent application describes a wall that is set up in sections such that each section contains products that are designed to treat a certain beauty issue. For example, one section may be named as “prepare” and include products that prepare the skin for application of makeup. Such products might include spot concealers, dark circle correctors, and so on. Another section of the display will be devoted to another beauty issue such as “color”, which means that after the skin is prepared colors such as eyeshadow, lipstick, and the like can be applied to the face.

Cosmetics manufacturers have also extended the improved shopability concept to hair color. U.S. patent application Ser. No. 11/424,328, filed Jun. 15, 2006, is directed to a method and display for merchandising hair color. In one embodiment, the hair color kits suitable for use with light, medium, and dark hair are sold in separate sections of the display respectively. For example, the consumer need only identify her hair color as “light”, then shop in the section of the display that contains hair color products suitable for use with those that have light hair. Any product in the “light” section will be provide a generally acceptable result for her.

Mass market cosmetics users continue to design their walls with the ultimate aim of having them serve, as nearly as possible, as stationary beauty advisors. In this model, the shopper is required to make only one or two simple decisions about matters such as hair color, eye color, and the like, then shop at the section of the wall containing products that are pre-selected and color coordinated for the category into which she has placed herself.

Such a simple step wise approach to cosmetic purchases would be particularly relevant in the nail category. There are a plethora of product offerings for nails. In a typical self-select shopping environment the nail products (such as nail enamel, cuticle cream, nail enamel top coat, hand cream, etc.) are simply carded and stored on the retail display shelves. The shopper must rely on guesswork or her own knowledge to select the products that are best for her. The shopper can easily make errors or purchase the wrong products. This is particularly true when the nail products are to be used in a step-wise grooming regimen.

Accordingly, there is a need for nail products used in a step-wise process for nail grooming to be packaged and merchandised in such a way that the consumer will be able to easily select the products that are to be used in each step, and be assured of purchasing each of the products that are necessary to practice the step-wise grooming process.

It is an object of the invention to provide a process for merchandising products to be used in a stepwise process for grooming nails.

It is a further object of the invention to provide a retail display for merchandising nail products to be used in a step-wise process for grooming nails where the products used in each step of the process are found on a separate section of the display and are clearly marked with indicia indicating the step the particular product is to be used in.

It is a further object of the invention to merchandise nail products to be used in a step-wise process for grooming the nails where each of the nail products are sold in a blister pack which is printed with indicia indicating the step of the process the particular nail product is to be used in.

### SUMMARY OF THE INVENTION

The invention is directed to a blister pack comprised of a card having a product to be used in a stepwise process for grooming the nails blistered thereto wherein the card contains indicia noting the step of the stepwise nail grooming process the blistered product is to be used in.

The invention is further directed to a self-service merchandise display for nail care products to be used in a stepwise process for grooming the nails comprising:

a) a rack for holding and displaying a plurality of nail grooming products;

b) wherein said rack is divided into a plurality of adjacent sections corresponding to the steps in the stepwise process for grooming the nails;

c) wherein each individual section contains nail care products that are to be used in one step of the stepwise process for grooming nails.

A method for selling nail care products in a retail store environment, wherein said products are to be used in a stepwise process for grooming the nails comprising:

providing a first product for use in the first step of the process for grooming the nails and marking it with indicia identifying it for use in the first step,

providing a second product for use in the second step of the stepwise process for grooming the nails and identifying it for use in the second step,

and providing any additional number of products to be used in successive steps of the stepwise process for grooming the nails and identifying them by the step they are used in.

### DESCRIPTION OF THE DRAWINGS

FIG. 1: depicts a variety of nail care products that are used in the first step of a stepwise process for grooming the nails.

FIG. 2: depicts a variety of nail care products that are used in the second step of a stepwise process for grooming the nails.

FIG. 3: depicts a variety of nail care products that are used in the third step of a stepwise process for grooming the nails.

FIG. 4: depicts a variety of nail care products that are used in the fourth step of a stepwise process for grooming the nails.

FIG. 5: depicts the rear surface of the card 2 for the product in FIG. 2A, and is representative in depicting the type of information found on the card 2 rear surface.

FIG. 6: depicts one type of vertical planogram showing a wall with adjacent sections wherein each section contains nail care products to be used in a stepwise process for grooming nails.

### DETAILED DESCRIPTION

I. The Blister Pack

The first embodiment of the invention is directed to a blister pack. The blister pack is comprised of a card having a nail care product to be used in a stepwise process for grooming the nails blistered thereto.

A. The Card

The blister pack 1 comprises a card 2. The card generally has a front surface and a rear surface. The front surface is generally the surface that faces the shopper when the shopper is shopping at the display where the card is found. In general, the front surface is printed with information that is more important in terms of communication with the consumer. The rear surface of the card generally faces toward the display and is not visible to the shopper unless she removes the blister pack from the display and turns it over to read the graphics, text, or other indicia on the rear surface of the card. Typically, the card rear surface contains information such as the ingredient listing for ingredients found in any composition that is part of the product. Card rear surface will also often contain the name and address of the manufacturer of the product in small type (also referred to as mice type). The various items that may be found on the card are further described herein. Such items may be found either on the rear or front surface of the card.
1. Primary Indicator

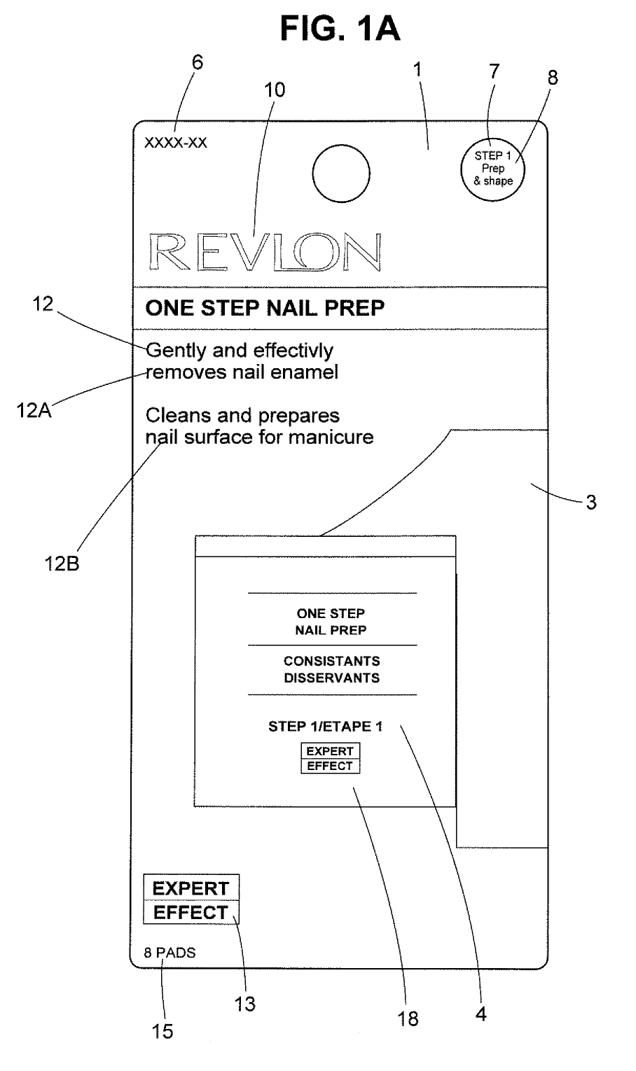

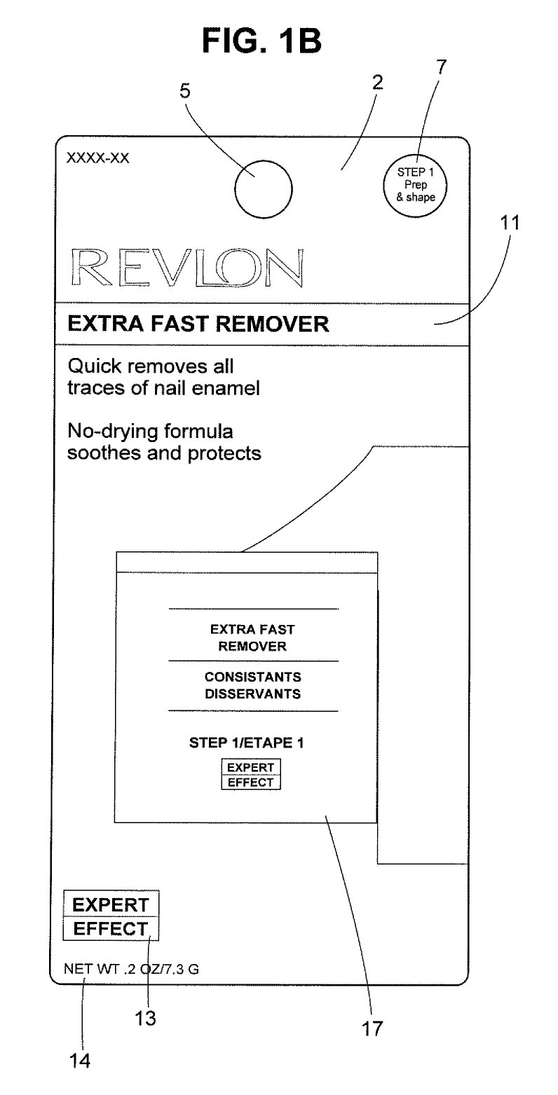

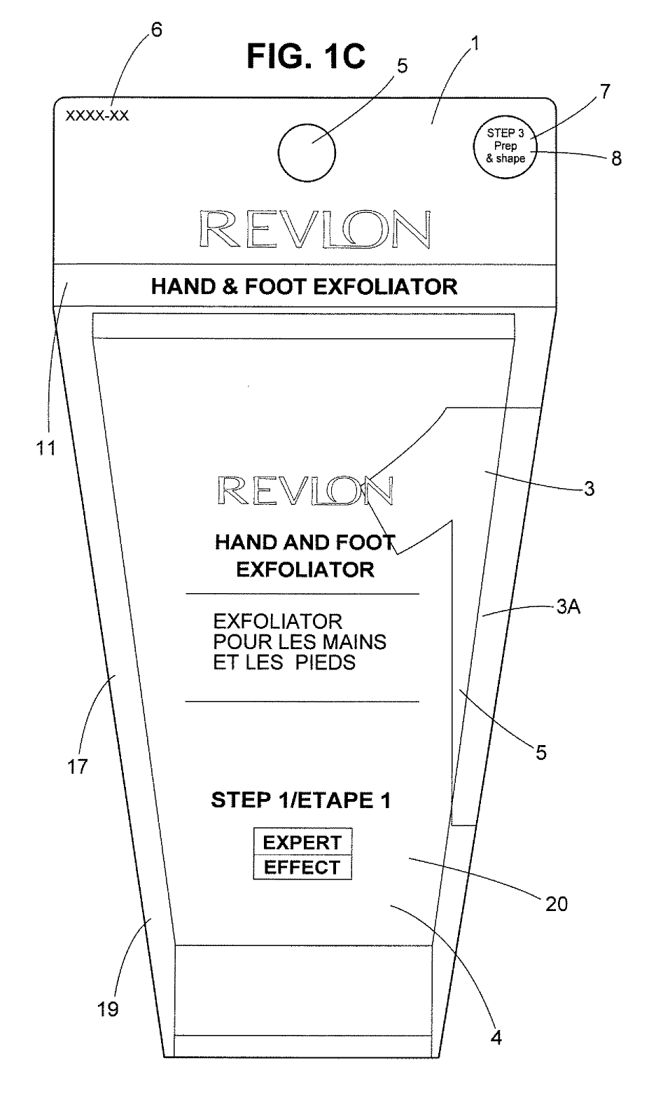

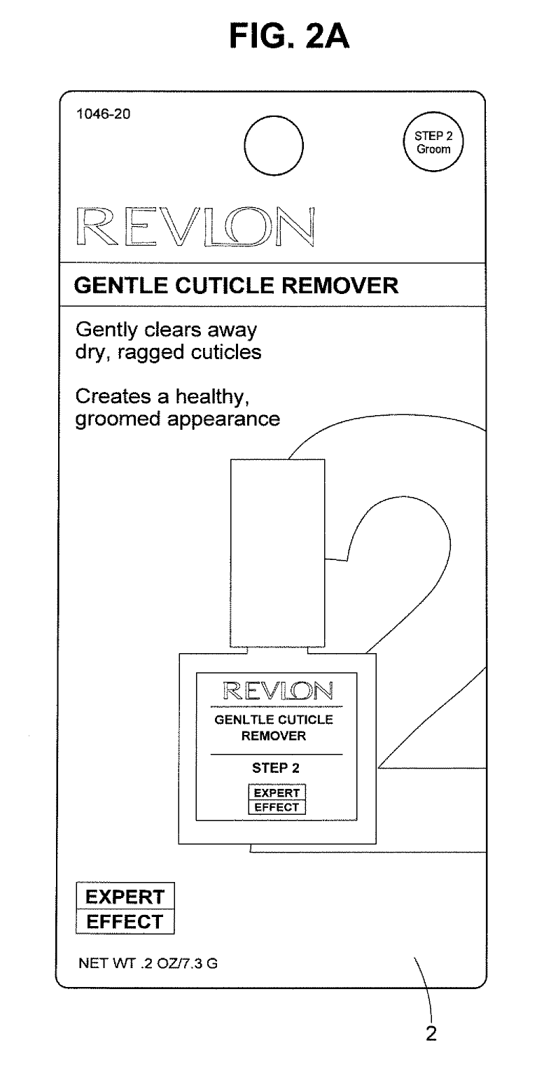

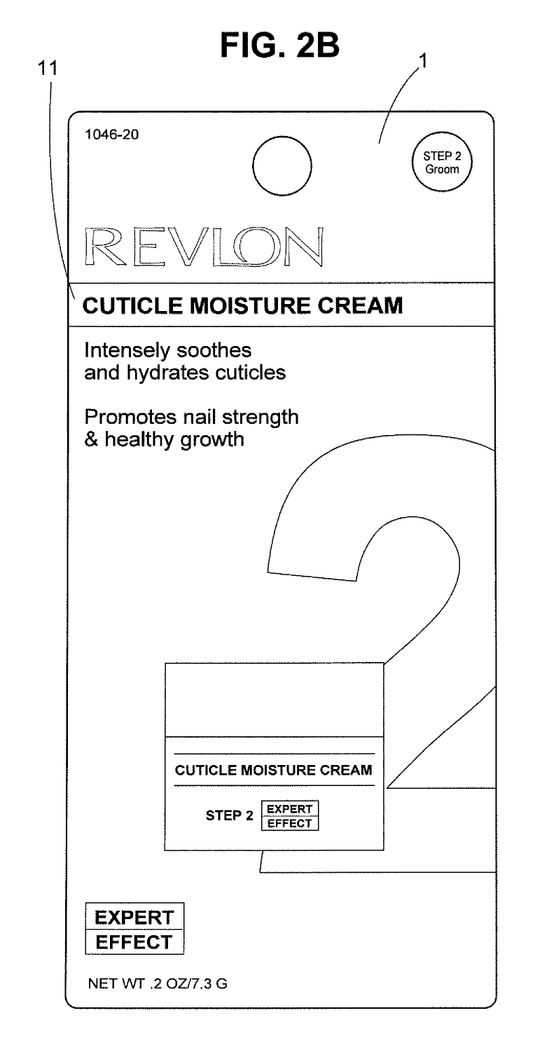

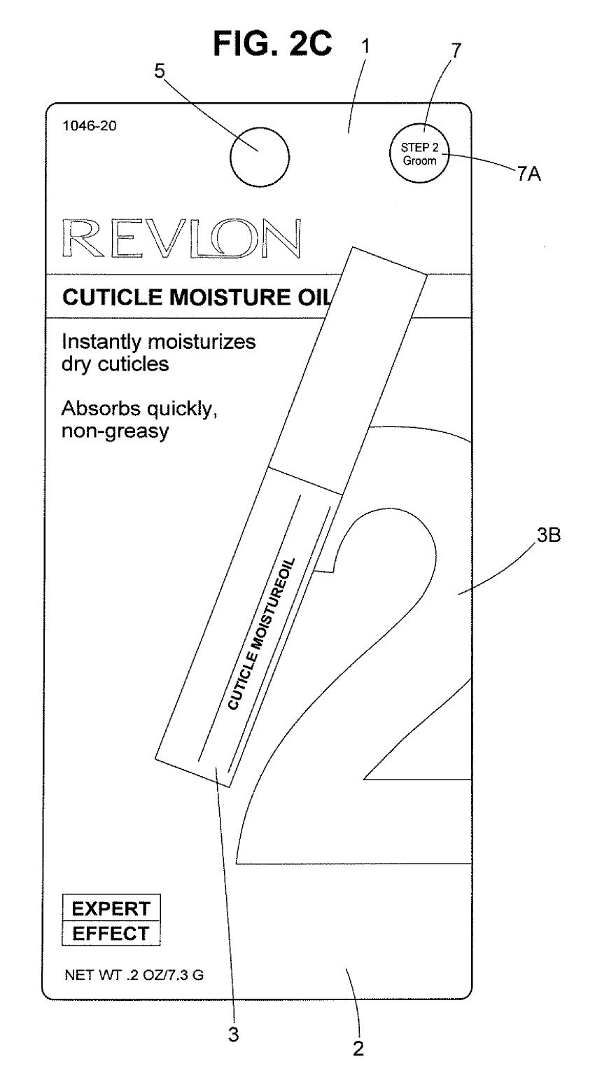

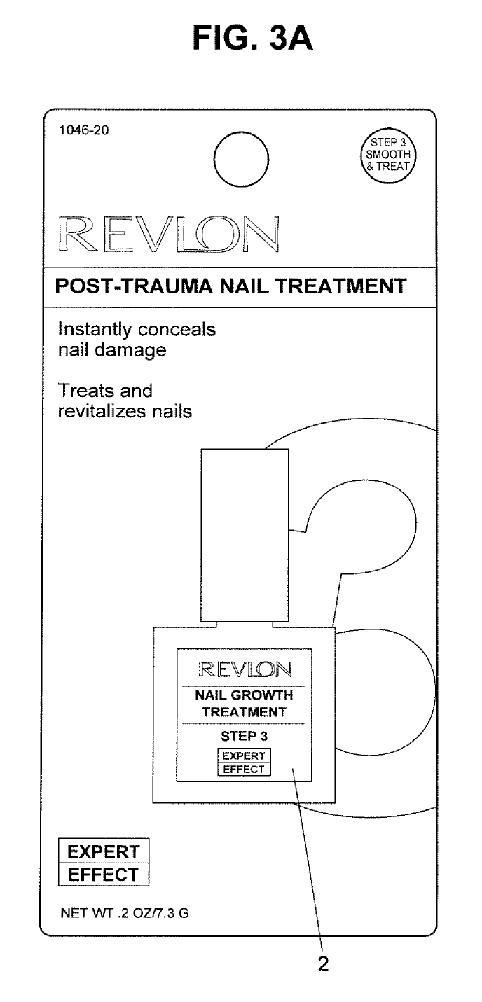

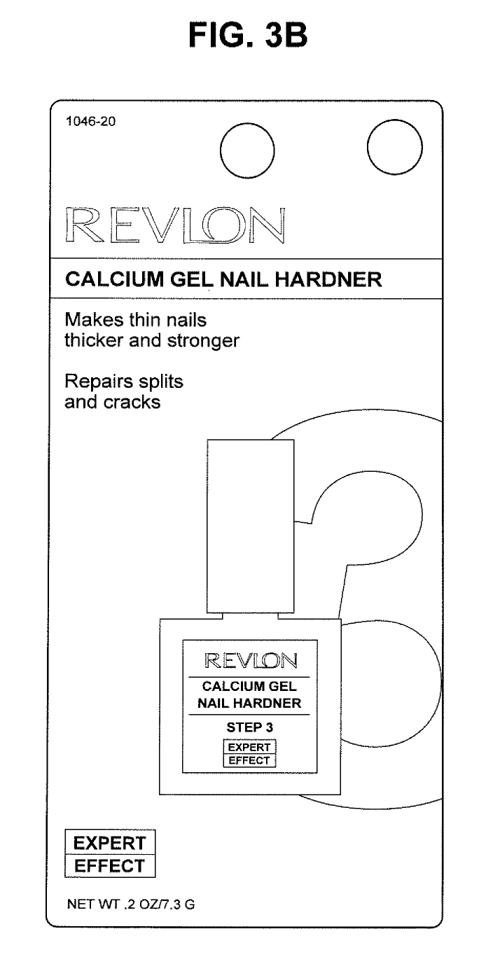

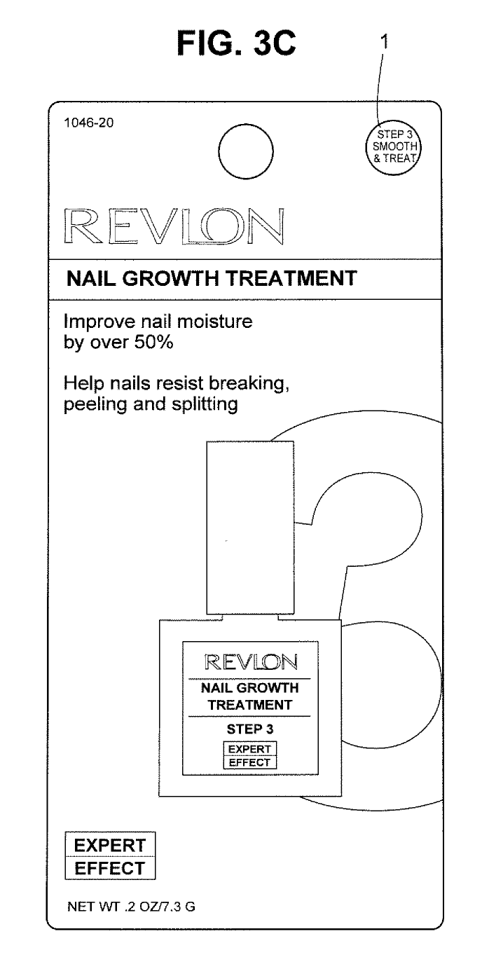

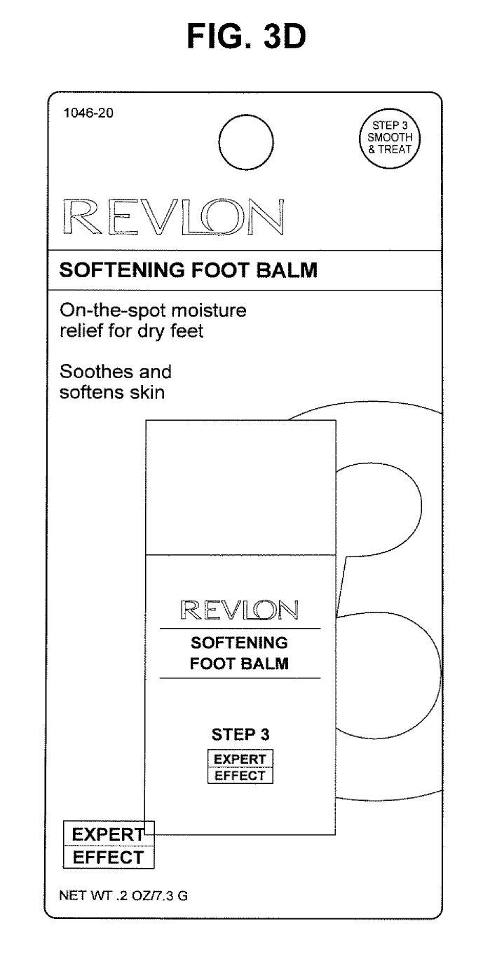

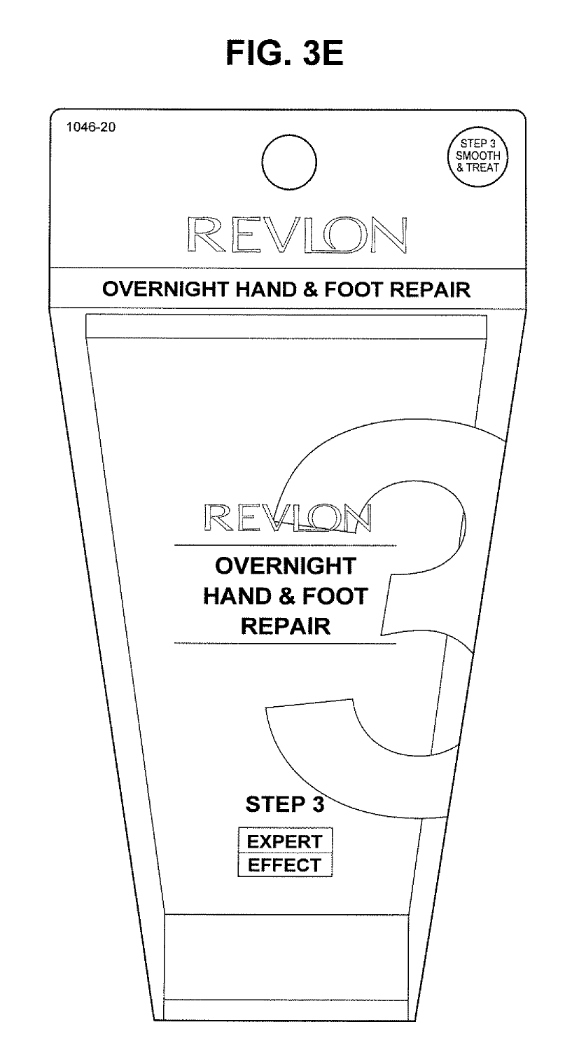

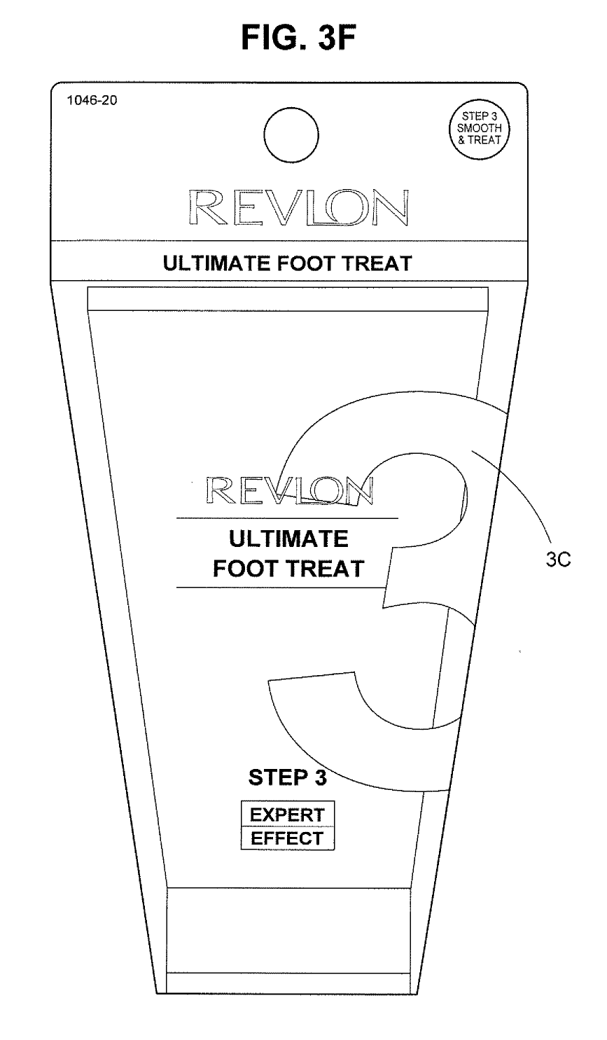

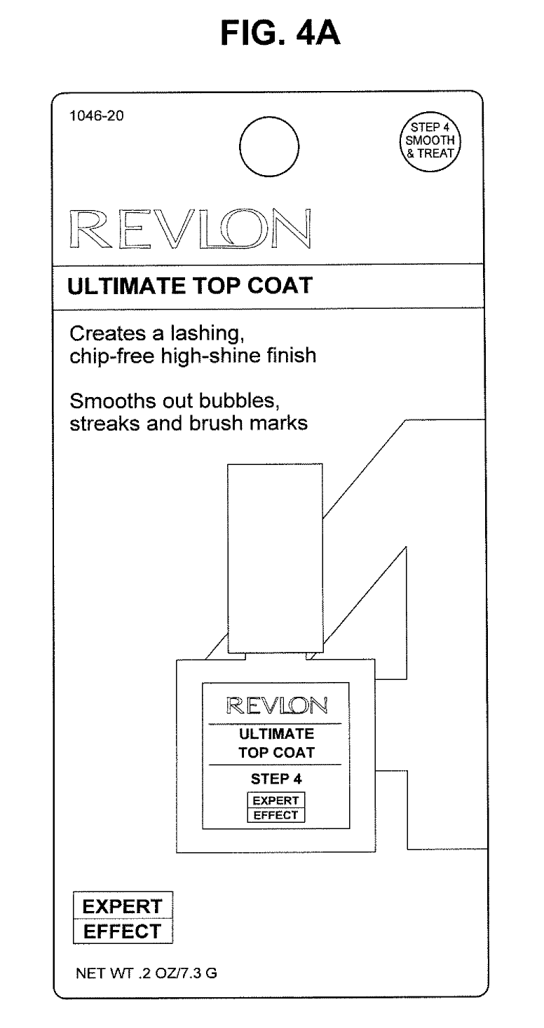

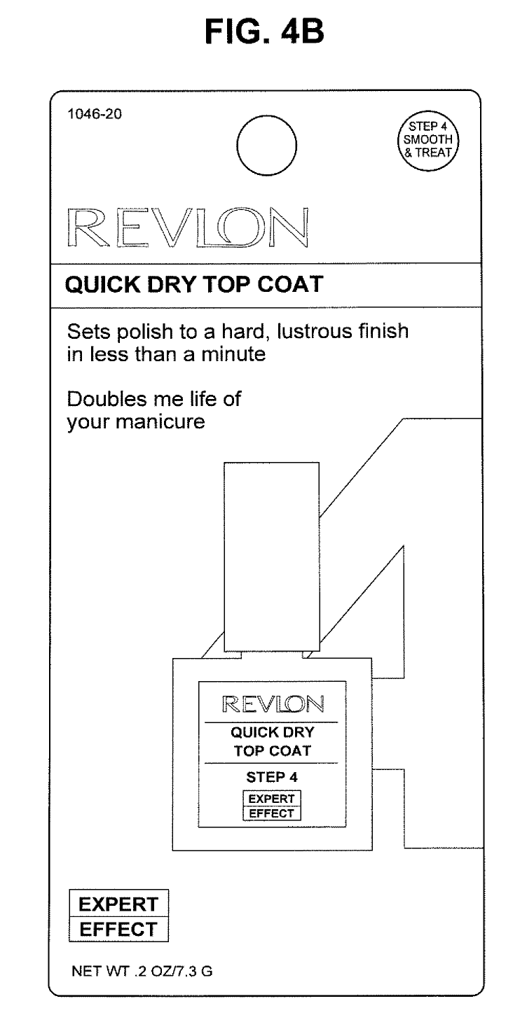

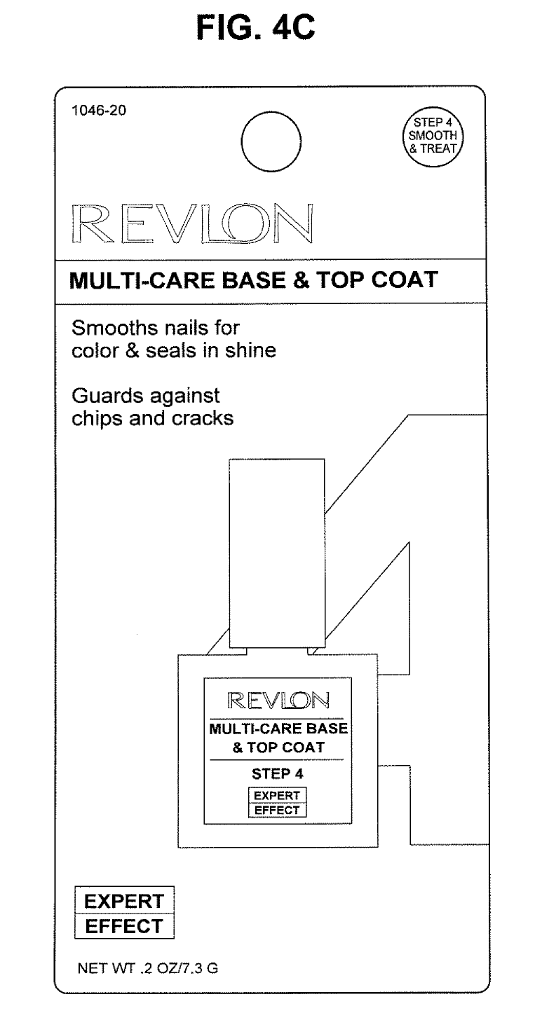

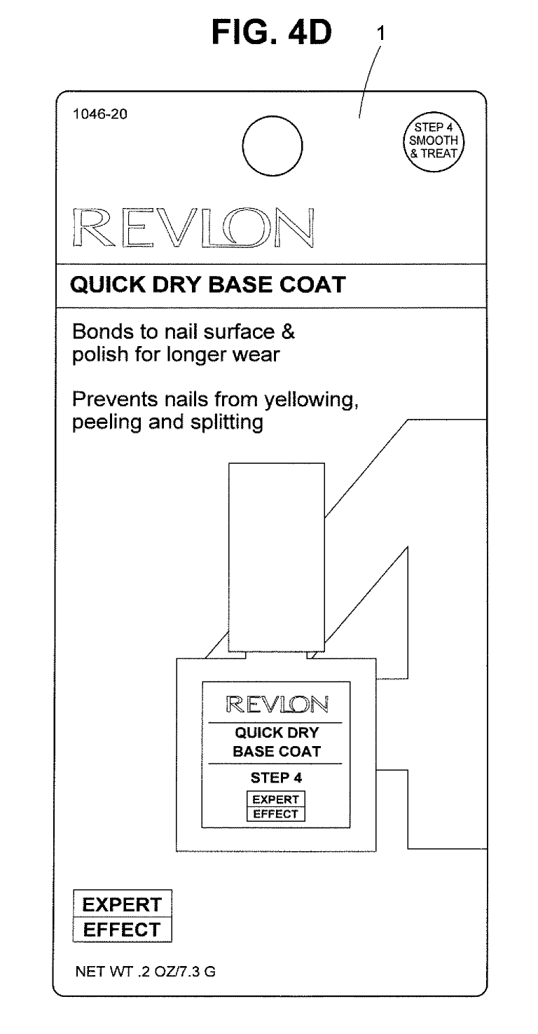

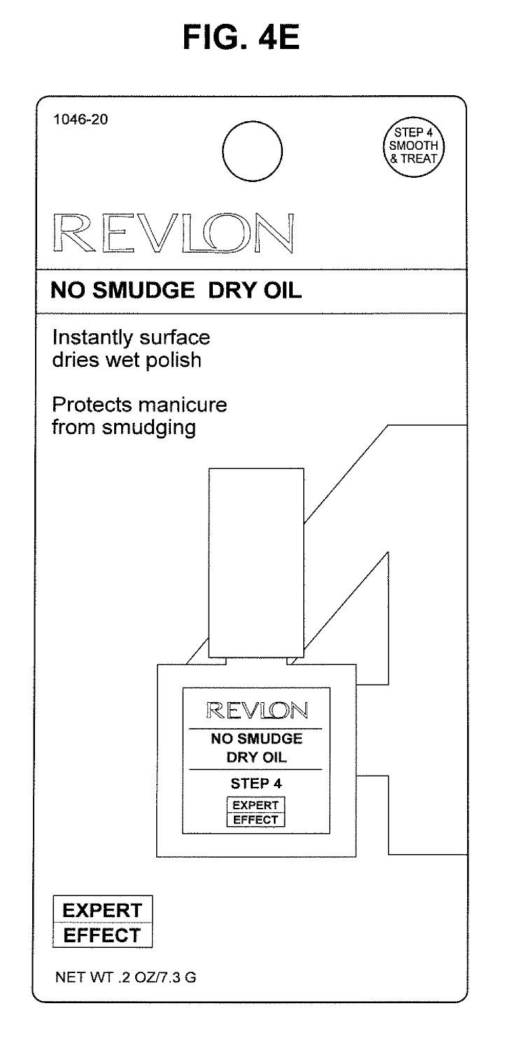

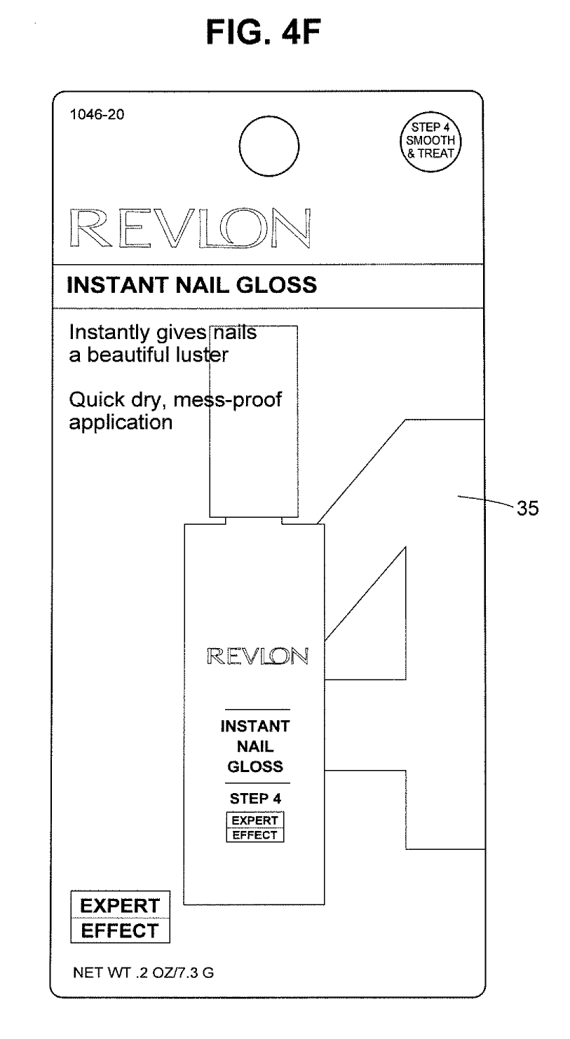

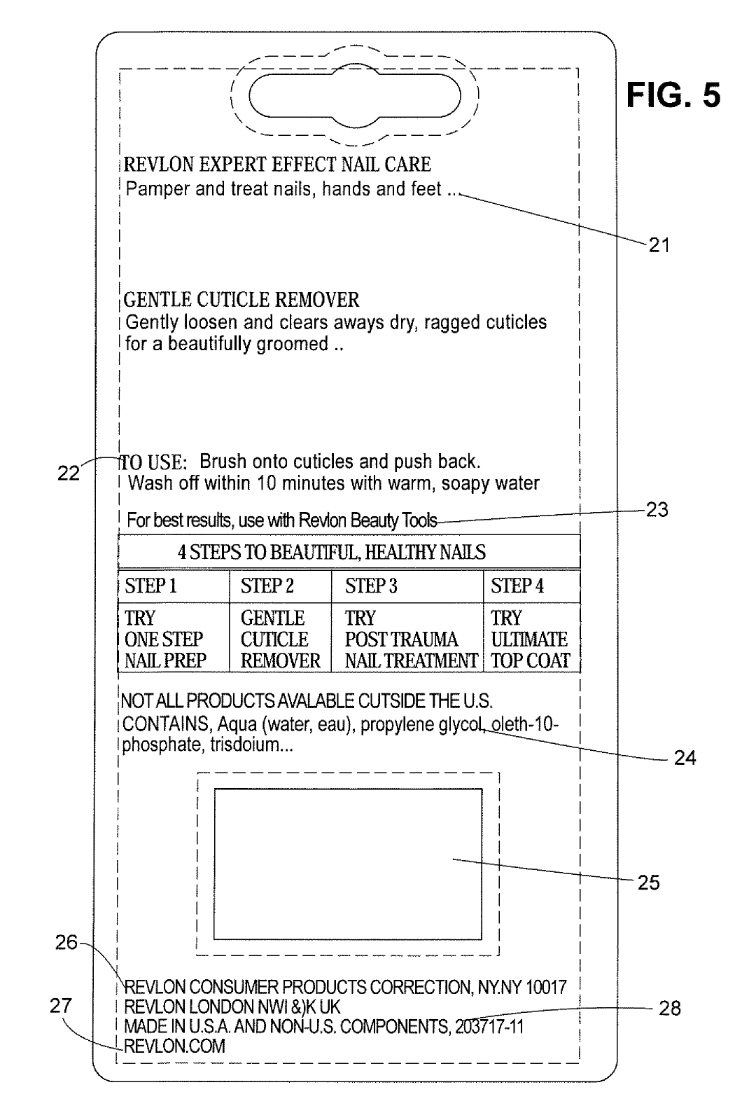

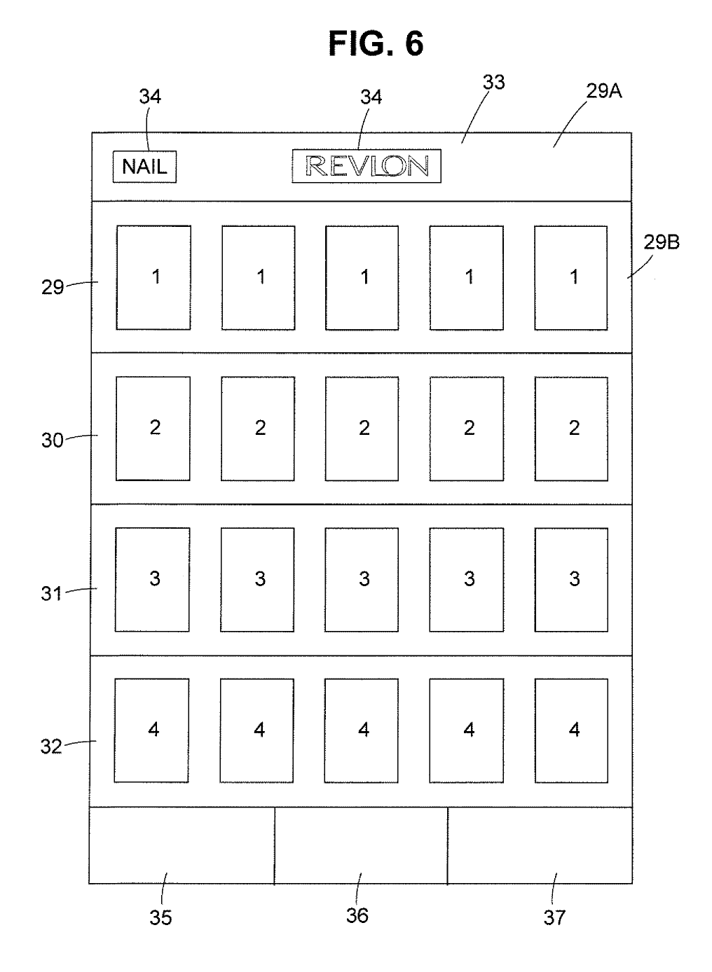

The card 2 has a primary indicator 3, such as a number. The primary indicator 3 denotes what step of the stepwise process the particular nail care product affixed to card 2 is used in. In the case of cards 2 depicted in FIGS. 1-4, for example, they contain primary indicators 3 which are numbers 3A, 3B, 3C, and 3D, that correspond to numbers 1, 2, 3, 4, which are the steps of the stepwise process in which the nail care products 4 are suggested for use in.

2. Hang Tag or Punch Hole

Card 2 may contain graphics and text to further assist the shopper in understanding the product, features that assist in retail merchandising, and the like. For example, card 2 may contain a punched hole 5 or hang tag, which facilitates hanging of the product on the hooks typically found on retail store displays. Such hooks may be part of the hook and hang type of display system or some other type of display system. Most often retail store displays are of the hook and hang type, which means a hook is attached to a wall and the product is hung from the hook.
3. SKU Number

Card 2 may also contain the manufacturer's product number 6, also referred to as a SKU (stock keeping unit) number. The term “SKU” means the lowest level of product detail. The product or SKU number is generally found in the form xxxx-xx, where the first four digits indicate the manufacturer's number for the product line, and the last two digits a sub-code that may indicate shade or a similar subcategory.
4. Secondary Indicator

Card 2 contains at least one primary indicator 3 that describes what step of the stepwise process the nail care product 4 affixed to the card 2 is used in. If desired, there may be a secondary indicator 7 of the step that the product 4 affixed to the card 2 is used in. Secondary indicator 7 generally comprises a repeat of the primary indicator 3 with respect to the step, possibly with the step written in text 7A along with additional explanatory text 8 or other identifying graphics that links the step denoted in primary indicator 3, and secondary indicator 7 with explanatory text 8 that further describes the end result when using the product 4 that is affixed to card 2.
5. Brand Identifier

Card 2 may contain a brand identifier 10, which identfies the brand of the product 4 tat is found within the blister pack 1. In this case, while the card 2 lists the brand identifier as “Revlon”, this disclosure shall not be limited to cards 2 where the brand identifier is Revlon, but rather includes cards with any brand identifier 10 listed, or no brand identifier listed.
6. Descriptor

Card 2 may further contain a short descriptor 11 that is readily visible to the shopper and further facilitates the shopper's understanding of what type of product is found in the blister pack 1.
7. List of Features and Benefits

Card 2 may also contain a list of the features and benefits 12, or what the product that is found in the blister pack actually does.
8. Sub-Brand Information

Card 2 may also contain a graphic indicating the sub-brand 13 of the product 4 found within the blister pack.
9. Weight or Quantity

Card 2 may also contain text or graphics that identify the weight 14 of the product 4 found within the blister pack 1 or quantity 15 of individual items found within the blister pack 1.
10. Explanatory Text

Card 2 may also contain explanatory text 21, which may include more detailed information about the features and benefits of the product, the end benefits it will provide.
11. Use Instructions

The card 2 may also contain use instructions 22, which provide the consumer with specific instructions on how to use the product in the blister pack 1. If desired, the use instructions may also contain ancillary use instructions 23, which are suggestions about using the product 4 in the bister pack 2 with other products sold by the manufacturer.
12. Ingredient Listing

The card 2 may contain a listing of the ingredients that are found in the composition for the product 4 that is affixed to the blister pack 1. The ingredient listing 24 (also called an MLI), lists the ingredients found in the composition in order of descending amounts. That is, the ingredient that is present in the largest amount is listed first, the ingredient present in the second largest amount listed second, and so on.
13. UPC Code

The card 2 also, preferably, contains a section for the UPC code 25. The UPC code is a uniform product identifier and enables the retailer to scan the product through the cash register to record the sale rather than the old fashioned ringing up of the item by its price at the cash register check out area.
14. Manufacturer Details

The card 2 also may contain further specific details location details about the product manufacturer such as full corporate name and address 26 and website address 27. Also, if desired, the site where the product was manufactured may be noted 28.
Any one or more of the above may be found on the card 2, either on the front or back surface of the card, as desired by the manufacturer. Preferably, one or more of items 1 through 9 mentioned herein are found on the front surface of the card 2 and items 10-14 are found on the rear surface of the card.

For example, FIG. 1A shows a nail care product 4 that is to be used in step 1 of a stepwise grooming process for nails, as indicated by the primary indicator 3 that is the number “1”. The primary indicator 3 is printed on card 2 in type large enough to enable the shopper to see it when shopping the wall. The card of FIG. 1A contains a punch hole 5, as well as a secondary indicator 7 that contains the second indication of the step in written text 7A (“step 1”) as well as explanatory text 8 (“prep & shape”) that states the desired benefit achieved with use of the product 4. This ties the step and the desired end benefit together for the shopper and enhances the shopper's understanding of the product and its benefits. The product of FIG. 1A further contains a product number 6 in the form xxxx-xx, and a brand identifier 10. The descriptor, 11A, “One Step Nail Prep” readily indicates to the consumer what the product in the blister pack 1 does. The product features and benefits 12 include a description of how the product 4 works—gently and effectively removes nail enamel 12A and cleans and prepares he nail surface for manicure 12B. The card 2 of FIG. 1 further contains an indication of the sub brand 13 (“Expert Effects”) of the product found within the blister pack 1, as well as an indication of the number of items 15 (“eight pads”) found in the product 4 found within the blister pack 1.

Similarly, the blister pack 1 depicted in FIG. 1B also contains the primary indicator 3, a “1” that denotes the product in the blister pack 1 is for use in step 1 of the stepwise process for grooming the nails. The card 2 of FIG. 1B also contains a punch hole 5 for affixing to a display in a retail environment, and the product number 6, which is printed on card 2. The brand identifier 10 is noted, as well as an additional descriptor 11 that tells the shopper in a few words what kind of product it is (e.g. extra fast remover). Features and benefits 12 are also noted on the card 2 of FIG. 1B. Specifically, the features and benefits 12 of product 4 within the blister pack 1 of FIG. 1B are “quickly removes all traces of nail enamel” and is a “non-drying formula” that “soothes and protects”.

Similarly the blister pack 1 depicted in FIG. 1C has a primary indictor 3, designated “1”, noting that the product 4 is to be used in step 1 of a stepwise process for treating and/or grooming nails. The card 2 also has a secondary indicator 7 with associated written text 8 that ties the step of the process the product 4 is used in with the desired end benefit, e.g. “prep and shape”. The blister pack depicted in FIG. 1C also contains a product number 6, a punch hole 5, the brand identifier 10, a descriptor 11 of the product found within the blister pack 1, etc.

Similarly, the other cards 2 depicted in the other FIGS. 1-4 may contain any one or more of the items listed herein.

B. Blister

Blistered to the card 2 is the product 4. The blister 17 may be in the form of a thermoformed plastic, preferably clear, so the consumer can see the product 4 that is blistered to the card 2. The blister 17 may be in the form of a thermoformed plastic 18 that is slightly larger than the product 4 and is designed to fit over the product 4, with edges that facilitate attachment to the front surface of card. Alternatively, blister 17 may be in the form of a thermoformed plastic or cardboard sleeve 19 that is designed to hold the product 4. An example of a blister 17 in such a form is depicted in FIG. 1C. The thermoformed plastic or cardboard sleeve 19 is suitable for containing the product 4, which is a tube 20 containing a cream to be used for exfoliating hands or feet. Blisters may be made from any type of thermoformable plastic, and are most preferably clear such that the shopper can see the product beneath the blister and, to the extent the blister covers any graphics or text, see them through the blister.

Examples of products 4 include, but are not limited to nail enamel remover wipes that are packaged in a package; nail enamel remover liquid dispensed from a bottle or jar, creams that may be dispensed from tubes or jars, bottles with caps, or bottles that have a cap with rod and brush assembly attached where the brush is used to apply a composition to the nails or cuticles; vials; vials with applicators such as doe foot applicators or brushes; and the like.

The steps of the stepwise process may be indicated by numbers, letters, graphics, or any other type of indicia, so long as it is clear to the user what step is associated with the product in question.

Examples of products that may be used in step 1 of a stepwise process for grooming the nails includes nail enamel remover pads, nail enamel remover liquid, cream or lotion for conditioning surrounding skin. The creams or lotions may have ancillary benefits such as exfoliation, moisturization, and so on.

Examples of products that may be used in step 2 of a stepwise process for grooming nails includes cuticle remover liquid, cuticle remover cream, cuticle moisturizer.

Examples of products that may be used in step 3 of a stepwise process for grooming nails includes compositions that conceal damaged areas on the nails such as cracks, splits, fissures; compositions that increase the thickness and strength of the nail; hand and/or foot repair or treatment creams or lotions.

Examples of products that may be used in step 4 of a stepwise process for grooming nails includes base coats, top coats, combined base and topcoat compositions, quick dry compositions, nail gloss (composition applied to nail enamel to increase gloss properties), and so on.
II. The Retail Display

The retail display 29A for selling the products 4 in self-service retail stores contains one or more racks 29B which are divided into sections, in particular sections for each product 4 used in each step of the nail grooming process. Such a rack 29B is designed to hold and display the various nail grooming products 4 used in the stepwise process for grooming nails. For example in the first section 29 of the rack 29B, products 4 suitable for use in step one of the stepwise process for grooming nails are found. In the second section 30 of rack 29B products 4 for use in step two of the stepwise process for grooming nails are found. In the third section 31 of rack 29B, products 4 for use in step three of the stepwise process for grooming nails are found. In the fourth section 32 of rack 29B, products 4 for use in step four of the stepwise process for grooming nails are found. The products used in each step of the stepwise process are marked with the number corresponding to the step they are used in. The shopper who desires to purchase nail grooming products will approach the retail display 29A, identify the products from each group that are suitable for use in the various steps of the nail grooming process, then select the desired products for purchase. The retail display 29A may also contain a header space 33 where the cosmetics manufacturer may put signage 34 that identifies the product category and brand, for example. The retail display 29A may also contain one or more additional sections 35, 36, 37, for storing other products for use in grooming the nails that are adjuncts to those used in the stepwise process.

The retail display 29A may be a stand alone display or it may be incorporated into another display. For example, it may be desirable to incorporate retail display 29A with a display for sale of items such as beauty tools, which are used with the nail grooming products, or other types of products.

The blister pack and retail display facilitate the shopper's experience and enable the shopper to better identify desirable products and purchase the appropriate products for use.

While the invention has been described in connection with the preferred embodiment, it is not intended to limit the scope of the invention to the particular form set forth but, on the contrary, it is intended to cover such alternatives, modifications, and equivalents as may be included within the spirit and scope of the invention as defined by the appended claims.

We claim:

1. A blister pack comprised of a card having a product to be used in a stepwise process for grooming the nails blistered thereto wherein the card contains indicia noting the step of the stepwise nail grooming process the blistered product is to be used in.

2. The card of claim 1 wherein the indicia are numbers.

3. The card of claim 1 wherein the indicia are letters.

4. The card of claim 1 wherein the indicia are graphics.

5. The card of claim 1 wherein the card also contains one or more of the following: (i) product manufacturer, (ii) product brand name, (iii) product sub-brand name, (iv) product description, (v) product number, (vi) ingredient listing, (vii) instructions for product use.

6. The blister pack of claim 1 wherein the nails to be groomed are fingernails.

7. The blister pack of claim 1 wherein the nails to be grooming are toenails.

8. The blister pack of claim 1 where in the stepwise process for grooming the nails the first product in the stepwise process is used to clean and prepare the nail and/or skin surface.

9. The blister pack of claim 8 wherein the first product in the stepwise process is one or more of nail enamel remover, skin conditioner, skin or nail cleanser.

10. The blister pack of claim 1 wherein the stepwise process for grooming the nails the second product in the stepwise process is used to treat cuticles.

11. The blister pack of claim 10 wherein the second product in the stepwise process is one or more of cuticle remover, cuticle moisture cream, or cuticle moisture oil.

12. The blister pack of claim 1 wherein the third product in the stepwise process is one or more of a product for concealing nail damage, product for repairing nail splits and cracks, product for moisturizing nails, product for moisturizing the skin of hands and/or feet.

13. The blister pack of claim 1 wherein the fourth product in the stepwise process is one or more of a nail enamel base coat, nail enamel top coat, nail enamel base and top coat, nail enamel drying composition, nail enamel gloss composition.

14. A self-service merchandise display for nail care products to be used in a stepwise process for grooming the nails comprising:
a) a rack for holding and displaying a plurality of nail grooming products;
b) wherein said rack is divided into a plurality of adjacent sections corresponding to the steps in the stepwise process for grooming the nails;
c) wherein each individual section contains nail care products that are to be used in one step of the stepwise process for grooming nails.

15. The display of claim 14 wherein the rack is divided into adjacent sections, wherein the step of the stepwise process that the nail care products are used in is numerically identified on the product.

16. The display of claim 15 wherein the rack contains four adjacent sections.

17. The display of claim 15 wherein the first section contains nail care products to be used in the first step of the stepwise process, the second section contains nail care products to be used in the second step of the stepwise process, the third section contains nail care products to be used in the third step of the stepwise process, and the fourth section contains nail care products to be used in the fourth step of the stepwise process.

18. A method for selling nail care products in a retail store environment, wherein said products are to be used in a stepwise process for grooming the nails comprising:
providing a first product for use in the first step of the process for grooming the nails and marking it with indicia identifying it for use in the first step,
providing a second product for use in the second step of the stepwise process for grooming the nails and identifying it for use in the second steps
and providing any additional number of products to be used in successive steps of the stepwise process for grooming the nails and identifying them by the step they are used in.

19. The method of claim 19 wherein the products for use in each step of the stepwise process are identified by a number that corresponds with the step in which they are to be used.

20. The method of claim 19 wherein the nail care products for use in each step of the stepwise process are placed into sections of a retail display wherein each section corresponds to the step of the stepwise process in which the nail care product is to be used.
